(19) United States
(12) Patent Application Publication
(10) Pub. No.: US 2026/0254187 A1
(43) Pub. Date: Aug. 27, 2026

(54) CHANNEL SCALABLE, COHERENT BEAM COMBINED LASER

(71) Applicant: Massachusetts Institute of Technology, Cambridge, MA (US)

(72) Inventors: Louis F. Isabella, Boston, MA (US); Kelsey D. Johnsen, Medford, MA (US); John Kyungbum Kim, Boxborough, MA (US); Luis F. Ortega, Arlington, MA (US); Niyom Lue, Nahant, MA (US); Tso Yee Fan, Belmont, MA (US); Yin Wan Tam, Wilmington, MA (US); Kan Thach, Dracut, MA (US)

(73) Assignee: Massachusetts Institute of Technology, Cambridge, MA (US)

(21) Appl. No.: 19/548,338

(22) Filed: Feb. 24, 2026

Related U.S. Application Data
(60) Provisional application No. 63/762,235, filed on Feb. 24, 2025.

(51) Int. Cl. H01S 3/067; H01S 3/00; H01S 3/10; H01S 3/106

(52) U.S. Cl. CPC H01S 3/06708; H01S 3/0057; H01S 3/10092; H01S 3/1068

(57) ABSTRACT

Described herein is a pulsed fiber laser system includes: a seed laser to generate signal light; and a phase modulator to phase modulate the signal light; a first gain stage to amplify the phase-modulated signal light; a fiber optical acousto-optic modulator (AOM) to pulse the amplified phase-modulated signal light; a second gain stage to amplify the pulsed signal light; a splitter to split the pulsed signal light into a plurality of pulsed signals; a plurality of channels each coupled to the splitter to receive a corresponding one of the plurality of pulsed signals, each of the plurality of channels having one or more gain stages to amplify the corresponding one of the plurality of pulsed signals and a transition of the amplified signal to free space; and a beam combiner to combine, in free space, the amplified signals of the plurality of channels.

### CROSS-REFERENCE TO RELATED APPLICATIONS

This application claims the benefit under 35 U.S.C. § 119 of U.S. Provisional Patent Application No. 63/762,235 filed on Feb. 24, 2025, which is incorporated herein by reference in its entirety.

### STATEMENT REGARDING FEDERALLY SPONSORED RESEARCH

This invention was made with government support under FA8702-15-D-0001 awarded by the U.S. Air Force. The government has certain rights in the invention.

### BACKGROUND

Fiber lasers are a class of lasers in which the active gain medium is an optical fiber. The fiber can be doped with one or more rare-earth elements, such as Ytterbium. Fiber amplifiers allow for laser technology to be integrated into size, weight, and power (SWaP) compliant forms for deployable systems for various applications.

Pulsed fiber lasers are a type of fiber lasers that emit light in the form of optical pulses, in contrast to continuous mode. Pulsed fiber lasers find use in many different types of systems and applications, including but not limited to sensing applications such as Light Detection and Ranging (LIDAR), 3D imaging and mapping, satellite-based terrain monitoring, free space optical communications, and various other sensing and communications applications.

### SUMMARY

Pulsed fiber laser systems exhibit important advantages compared to other types of laser systems, including but not limited to low size, weight, and power (SWaP), exceptional beam quality with stable beam pointing, adaptable thermal management solution, and versatile waveform generation capability. However, it is appreciated herein that the potential of a single channel pulsed fiber laser to scale both average and peak power can be constrained by technical limitations. Many applications demand average and peak powers higher than what can be provided by a single channel pulsed fiber laser. This disclosure provides a general methodology for constructing a channel-scalable pulsed fiber laser system through coherent beam combining, effectively addressing these power limitations. Illustrative embodiments of such a system are described in detail herein.

Previous implementations of high-power pulsed fiber lasers relied on photonic crystal fiber, trench fiber, or very-large mode area fiber amplification stages which, due to their length and other properties, generate too great of an accumulated B-integral to be coherently combinable. Disclosed systems and techniques enable power scaling of a laser system through addition of channels as opposed to increasing the power of individual channels.

According to one aspect of the present disclosure, a coherently combined pulsed fiber laser system architecture is disclosed. The architecture can reduce (and ideally minimize) the cumulative B-integral of amplified optical pulses while mitigating optical phase shifts resulting from the Kramer-Kronig relation introduced by energy saturation.

According to another aspect of the present disclosure, a low SWaP hybrid device for fiber lasers is disclosed. This hybrid device combines multiple components used in pulsed fiber laser construction into one single device. This not only reduces complexity, but also the overall fiber nonlinearities, enabling higher power pulsed fiber lasers.

According to another aspect of the present disclosure, structures and techniques for achieving faster turn on time of a pulsed fiber laser in a high-extinction burst mode are disclosed. This is referring to herein as “pre-pumped built-in gating.” Compared to the state of the art, pre-pumped built-in gating provides an increase in average power, a shorter rise time, and the ability to operate at higher frequency burst rates.

According to another aspect of the present disclosure, a small, compact method for monitoring the carrier frequency in a laser system with active pseudorandom bit sequence (PRBS) linewidth broadening. Previously this monitoring required the use of a large RF spectrum analyzer. Disclosed embodiments provide for a small, low SWaP circuit with a single numerical readout as a replacement.

According to another aspect of the present disclosure, a hollow core fiber for use with a pulsed coherent beam combining is described. Coherent beam combing allows for power scaling of pulsed fiber lasers. The amount of power that any one optical fiber with a glass core is limited by inherent nonlinearities. By using an air core instead of a glass core, hollow core fibers allow peak powers orders of magnitude higher than any fibers with a glass core. This allows for numerous applications in beam delivery systems and coherent combining architectures for high peak power pulsed fiber lasers.

According to another aspect of the present disclosure, described is a method for low-loss coupling of a laser beam from a pump signal combiner to a highly-doped rare-earth fiber within a fiber amplifier. This transition can encompass both signal beam and the pump beam. It is demonstrated herein that, using the disclosed method, notable enhancements can be achieved, including augmentation of laser signal output beam quality generated from the fiber amplifier. Furthermore, the method ensures consistency and repeatability in the quality of the laser signal beam, which contributes to the overall effectiveness of the system.

In some embodiments, a pulsed fiber laser system can comprise: a seed laser configured to generate signal light; and a phase modulator coupled to the seed laser to phase modulate the signal light; a first gain stage coupled to the phase modulator to amplify the phase-modulated signal light; a fiber optical acousto-optic modulator (AOM) coupled to the first gain stage to pulse the amplified phase-modulated signal light; a second gain stage coupled to the fiber AOM to amplify the pulsed signal light; a splitter coupled to the second gain stage to split the pulsed signal light into a plurality of pulsed signals; a plurality of channels each coupled to the splitter to receive a corresponding one of the plurality of pulsed signals, each of the plurality of channels comprising one or more gain stages to amplify the corresponding one of the plurality of pulsed signals and a transition of the amplified signal to free space; and a beam combiner coupled to combine, in free space, the amplified signals of the plurality of channels. Each of the channels can further include an optical delay line, an intensity modulator, and a phase modulator.

The signal light generated by the seed laser can be continuous-wave (CW) light. The one or more gain stages of at least one of the plurality of channels can include a plurality of gain stages arranged in cascade. The beam combiner can include a parallel plate combiner. The system can include one or more hollow core fibers. The system can include a high-doped fiber amplifier (HDFA) array corresponding to at least a portion of the one or more gain stages of the plurality of channels.

For at least one of the plurality of channels, the one or more gain stages includes a gain stage having multiple gain stage components integrated within a single hybrid device. The hybrid device can include: an input; a wavelength division multiplexing (WDM) filter coupled to the input; a forward tap filter coupled to the WDM filter; an isolator coupled to the forward tap filter; an amplified spontaneous emission (ASE) filter coupled to the isolator; and a backward tap filter coupled to the ASE filter; and an output coupled to the backward tap filter. The input of the hybrid device can include: a pump input fiber to carry pump light into the device; a signal input fiber to carry signal light into device and also carry pump light out of the device; and a tap signal output fiber to carry a portion of the pump light and/or signal light out of the device. The output of the hybrid device can include: a signal output fiber to carry signal light out of device; and a backward tap output fiber to carry, out of the device, a portion of backward propagating light generated downstream of device.

The system can further include one or more fiber arrangements comprising: a first section of 10/125 um pump signal combiner output fiber; a second section of 125 um coreless fiber; a third section of 100/140 um graded index fiber; and a fourth section of high doped Yb fiber. The four sections can be spliced together. A length of the second section can be about 330 um. A length of the third section can be about 150 um.

The phase modulator can be configured to suppress stimulated Brillouin scattering (SBS) within the system. The system can include a suppression monitoring device to monitor the SBS suppression. The suppression monitoring device can include: an input configured to receive a signal from a photodetector; a power splitter coupled to the input and configured to split the signal into a first signal (Vfull) and a second signal (Vbp); a bandpass filter coupled to the power splitter to receive and filter the second signal; a measurement board coupled to receive the first signal and the filtered second signal and configured to calculate an amplitude ratio (Vratio) based on the first signal and the filtered second signal; and an output to provide the amplitude ratio.

In some embodiments, a method for controlling a burst mode of a fiber laser system can include: at a first time, commencing energization of a first fiber amplifier; at a second time after the first time, changing a modulator to an ON state to allow signal light to pass to an input of the first fiber amplifier; and at a third time after the first time, commencing energization of a second fiber amplifier coupled to an output of the first fiber amplifier. The third time can be before the second time.

It should be appreciated that individual elements of different embodiments described herein may be combined to form other embodiments not specifically set forth above. Various elements, which are described in the context of a single embodiment, may also be provided separately or in any suitable sub-combination. It should also be appreciated that other embodiments not specifically described herein are also within the scope of the following claims.

### BRIEF DESCRIPTION OF THE DRAWINGS

The manner of making and using the disclosed subject matter may be appreciated by reference to the detailed description in connection with the drawings, in which like reference numerals identify like elements.

FIG. 1 is a block diagram showing an example of a coherently combined pulsed fiber laser system, according to some embodiments of the present disclosure.

FIG. 1A is a block diagram showing another example of a coherently combined pulsed fiber laser system, according to some embodiments of the present disclosure.

FIG. 2 is a schematic diagram of a fiber amplifier gain stage that can be provided for use within a fiber laser system.

FIG. 2A is a pictorial diagram showing individual packaging of components of a fiber gain stage.

FIG. 3 is an optical diagram a hybrid device for use within a fiber laser system, according to some embodiments.

FIG. 3A illustrates packaging of the hybrid device of FIG. 3, according to some embodiments.

FIG. 4 is a block diagram of a laser system with pre-pumped built-in gating for burst mode, according to some embodiments.

FIG. 5A is a graphical diagram showing conventional control timing for turning on burst mode in a laser system with built-in gating.

FIG. 5B is a graphical diagram showing control timing that can be used to turn on burst mode in the laser system of FIG. 4 with pre-pumped built-in gating.

FIGS. 6A and 6B are graphical diagrams showing average power output for a laser system in burst mode using pre-pumped built-in gating.

FIG. 7 is a block diagram of a pulsed fiber laser system with active pseudorandom bit sequence (PRBS) linewidth broadening.

FIG. 8 is a pictorial diagram of a conventional carrier suppression monitoring setup.

FIG. 9A is a graphical diagram showing an RF Spectrum with unsuppressed carrier tone.

FIG. 9B is a graphical diagram showing an RF spectrum of PRBS tones with carrier suppressed.

FIG. 10 is a pictorial diagram of an improved carrier suppression monitoring circuit, according to some embodiments.

FIG. 11 is a pictorial diagram of a hollow core fiber that can be used within a coherently combined pulsed fiber laser system, according to some embodiments.

FIG. 12 is an optical diagram of hollow core fiber coherent beam combining setup, according to some embodiments.

FIGS. 13A and 13B are pictorial diagrams respectively showing near field and far field output of single hollow core fiber.

FIG. 14A is a graphical diagram illustrating pulse output from hollow core fiber.

FIG. 14B is a graphical diagram illustrating continuous-wave (CW) beam combining power and efficiency.

FIGS. 15A and 15B are pictorial diagrams respectively showing CW beam combining near field and far field.

FIG. 16 is a graphical diagram illustrating pulsed beam combining power and efficiency.

FIG. 17A is a conceptual diagram of a 25-output channel for coherent beam combining using packaged amplifiers to launch the beams into free space.

FIG. 17B is a conceptual diagram of a 25-output channel for coherent beam combining using the hollow-core fibers to launch the beams into free space, according to some embodiments.

FIG. 18 is a series of graphical diagrams depicting transition of a signal beam from a pump signal combiner into a highly rare earth doped fiber within a fiber amplifier, according to some embodiments.

The drawings are not necessarily to scale, or inclusive of all elements of a system, emphasis instead generally being placed upon illustrating the concepts, structures, and techniques sought to be protected herein.

### DETAILED DESCRIPTION

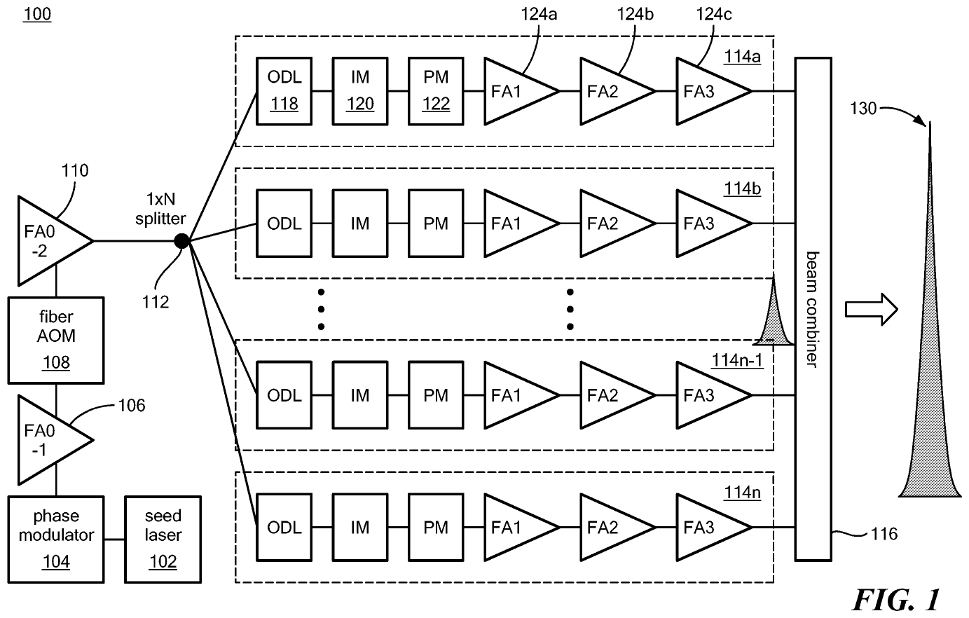

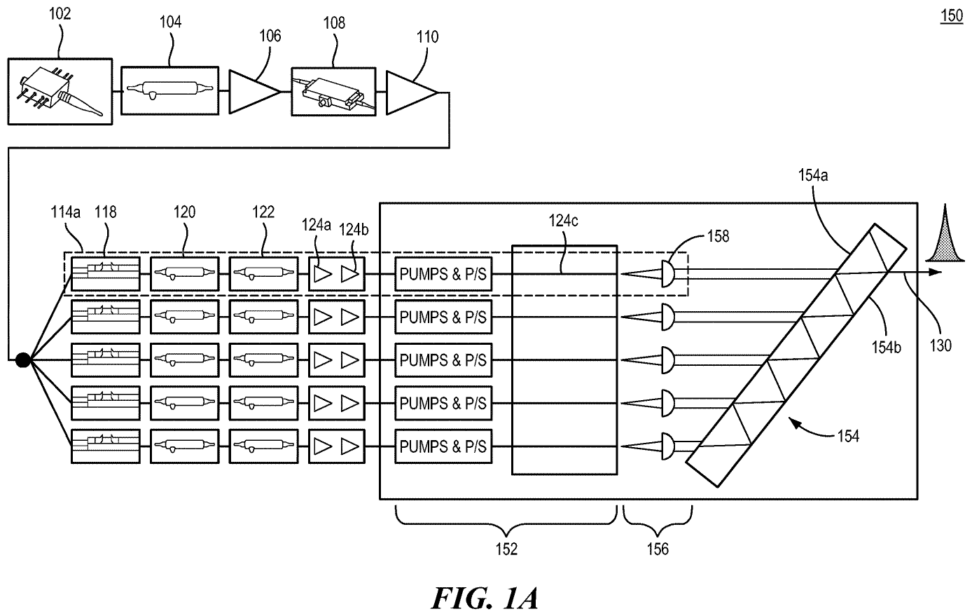

FIG. 1 shows an example of a coherently combined pulsed fiber laser system 100 configured to generate and radiate a pulsed laser beam 130 into free space, according to some embodiments. The overarching design principle of this system resolves around two key objectives: 1) minimizing the cumulative B-integral of amplified optical pulses, and 2) mitigating optical phase shifts resulting from the Kramer-Kronig relation introduced by energy saturation.

Illustrative system 100 includes a seed laser 102 (e.g., a coherently combinable seed laser), a phase modulator 104, a first-stage fiber amplifier (FA0-1) 106, a fiber optical acousto-optic modulator (AOM) 108, a second-stage fiber amplifier (FA0-2) 110, an 1×N splitter 112, a plurality (N) of channels 114a-n (114 generally), and a beam combiner 116. Each of the channels 114 may be similarly configured. Representative channel 114a includes a fiber optic delay line (ODL) 118, a bias-controlled intensity modulator (IM) 120, a phase modulator (PM) 122, and a three-stage fiber amplifier 124 comprised of three cascaded amplifiers 124a-c (FA1, FA2, and FA3). These various system and channel components may be coupled together as shown using segments of optical fiber (also referred to herein as simply “fiber”), for example.

System 100 can generate pulsed laser beam 130 via a process that commences with a coherently combinable seed laser 102 with a narrow linewidth. The seed laser's 102 output undergoes phase modulation (phase modulator 104), effectively suppressing stimulated Brillouin scattering within the system.

The ensuing phase-modulated optical signal receives amplification through first-stage fiber amplifier 106. The amplified continuous-wave (CW) signal is subsequently introduced into fiber optical acousto-optic modulator 108, where the CW signal is carved into a pulsed signal (e.g., 50 ns pulses). This pulsed signal then undergoes amplification via second-stage fiber amplifier 110. Following amplification, the pulsed signal is split (splitter 112) into N-channels 114a-n. Each of these signals enters a fiber optic delay line, 118 which facilitates fine path length matching alignment. In conjunction, coarse path length matching can be achieved with fiber addition or subtraction via fiber cleaving and splicing.

In some embodiments, first-stage fiber amplifier 106 and second-stage fiber amplifier 110 can be pumped by a pump laser (e.g., a pump laser diode) having a particular wavelength. In some cases, the wavelength can be about 976 nm, coinciding with Ytterbium-doped fiber's resonant absorption peak, effectively reducing effective Ytterbium-doped fiber length.

To address energy saturation, bias-controlled intensity modulator 120 can be provided. Driven by an amplified electrical signal from a high-speed arbitrary waveform generator (not shown), intensity modulator 120 is responsible for producing short pulses in the system. Intensity modulator 120 can function similarly to AOM 108. In some examples, intensity modulator 120 can carve 50 ns pulses introduced by the waveform generator into a 5 ns pulse. A phase modulator 122 within each channel functions as an optical phase controller, ensuring constructive interference of all N channels for coherently beam combining.

In each channel, first-stage fiber amplifier (FA1) 124a can utilize co- and clad-pumped Ytterbium-doped fiber amplification, maintaining a lower ratio of output pulse energy to Ytterbium-doped fiber saturation energy. Similarly, second-stage fiber amplifier (FA2) 124b can employ counter- and clad-pumped ytterbium-doped fiber amplification, also maintaining a lower ratio. Third and final-stage fiber amplifier (FA3) 124c can employ co- and clad-pumped fiber amplification. Unlike the first two stages (FA1 and FA2), the third-stage amplifier 124c may utilize non-silica, highly-doped fiber to enhance Ytterbium doping concentration without encountering photodarkening. This results in a substantial reduction in the accumulated B-integral.

Given that fiber nonlinearities can generally accumulate from the first-stage amplifier 124a through the second- and third-stage amplifiers 124b,c, the lengths of both passive fibers and Ytterbium-doped fibers can be careful optimization for cascaded three-stage fiber amplifiers.

In some embodiments, amplifiers 124a-c can be pumped by a pump laser (e.g., a pump laser diode) having a particular wavelength. In some cases, the wavelength can be about 976 nm, coinciding with Ytterbium-doped fiber's resonant absorption peak, effectively reducing effective Ytterbium-doped fiber length.

The per-channel optic delay lines 118 can each have a length selected to achieve matching fiber lengths across the plurality of channels 114, resulting in strong coherence between channels and of the combined output beam 130.

The per-channel intensity modulators 120 can function similar to optical acousto-optic modulator 108, but can each controlled individually per channel to achieve desired pulse carving. In some examples, intensity modulators 120 can operate faster in terms of bandwidth compared to acousto-optic modulator 108.

The per-channel phase modulators 122 can be operated to align signal phase across the multiple channels. There may be phase offset across the multiple channels due to thermal conditions, vibration, mechanical movement, or other factors. Phase modulators 122 can be provided to eliminate such offset, allowing the plurality of channels signals to be combined into a high-power beam using constructive interference.

As previously discussed, each channel can include a three-stage fiber amplifier 124. First- and second-stage amplifiers 124,b may be provided as cascaded preamplifiers, and third-stage (or “final-stage”) amplifier 124c can be provided as a highly-doped amplifier. In some embodiments, first- and second-stage amplifiers 124,b may include silica glass fiber, whereas third-stage amplifier 124c may include a non-silica fiber (e.g., to allow for a higher doping level and/or shorter fiber lens). While system 100 of FIG. 1 is shown as having a 3-stage fiber amplifier 124 in each channel 114, other numbers and/or arrangements of fiber amplifiers may be provided.

Beam combiner 116 can combine the amplified signals output by each channel 114 into a coherent laser beam 130. In some embodiments, system 100 can be configured to transition the plurality of per-channel signals from fiber to free space, and beam combiner 116 can combine the multiple free-space beams (e.g., using constructive interference) into a single high-power laser beam. In some embodiments, beam combiner 116 may include a parallel plate-type combiner, such as illustrated in FIG. 1A. In some embodiments, beam combiner 116 may include an optical phased-array combiner (e.g., a circular or square array) configured to overlap the multiple channel beams in the far field, to provide a coherent high power output beam. In some embodiments, beam combiner 116 may include a curved optical surface to combine and focus multiple channel beams into a coherent output beam. Other types of beam combiners may be used.

The architecture of the coherently combined, pulsed fiber laser system 100 supports channel scalability for both average and peak power scaling while maintaining exception beam quality. Illustrative system 100 can provide pulse energy output having average power sufficiently high for many types of applications including but not limited to LIDAR, satellite-based terrain monitoring/sensing, free space optical communications, etc.

The number (N) of channels 114 may be selected based on the requirements of a given application. For example, N may be selected to achieve a certain average beam power, peak beam power, beam quality, and/or process energy. In general, N may be increased to achieve increased beam power (e.g., increased average power). In one particular example, N=5, meaning that splitter 112 can be provided as a 1-by-5 splitter and beam combiner 116 may be provided as a 5-to-1 combiner.

FIG. 1 is intended to illustrate a general architecture of a coherently combined pulsed fiber laser system and, as such, not every system component is shown. For example, a coherently combined pulsed fiber laser system according to the present disclosure may include radiofrequency (RF) electronics to drive the seed laser 102, high-speed clocking and timing electronics to synchronize the plurality of channel phase modulators 122, etc. In one specific example, electronics may be provided to switch fiber optical acousto-optic modulator 108 on and off at a certain repetition rate to generate pulses of a desired duration/width for a given application (e.g., a repetition rate of 100 KHz to produce 50 ns pulses). As another example, optical isolators may be provided between different stages (e.g., between each stage) of a coherently combined pulsed fiber laser system. These isolators help prevent light from travelling upstream and damaging the optics. The isolators may include a bandpass filter to help reduce any amplified spontaneous emission (ASE)

Turning to FIG. 1A, in which elements of FIG. 1 are identified using like reference numerals, a coherently combined pulsed fiber laser system 150 can include a high-doped fiber amplifier (HDFA) array 152 optically coupled to a parallel plate combiner 154 via N lenses 156, one per channel. In this example, N=5.

The HDFA array 152 can include the final-stage amplifiers (S3) for each of the N channels. For example, HDFA array 152 can include final-stage amplifier 124c for representative channel 114a, as shown. At the outputs of HDFA array 152, transition can be made from fiber to free space/air. For example, an end cap may be disposed at the distal end of final-stage amplifier 124c. One side of the end cap can have a flat surface and the other side can have an angular surface. The surfaces can be formed using a grinding and/or polishing technique. An antireflection dielectric coating can be applied on the angled side to minimize band reflection. The end cap ca be fused to fiber using an arc welding (or “fusion splicing”) technique.

The N beams emitted by the N channels may be divergent. Thus, each beam can be passed through a respective one of the N lenses 156 configured to collimate the beams prior to combining. In some embodiments, mirrors and/or other optical elements can be provided to assist in aligning the beams in order to coherently combine them.

Parallel plate combiner 154 can include two plates 154a,b arranged parallel to each other and separated by a distance. The plates 154a,b may be partially reflective to allow light from one channel to pass through a plate and combine with light from another channel, and then allow this combined light to reflect back and combine with light from yet another channel, and so on, until all of the channel light is combined to output a coherent laser beam 130.

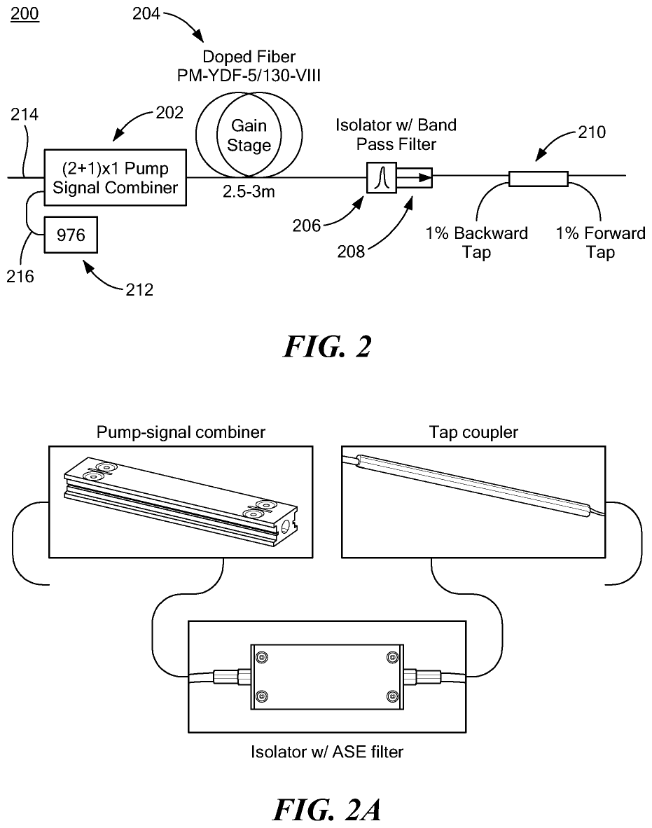

Turning to FIG. 2, fiber laser systems (e.g., system 100 of FIG. 1) can include multiple gain stages to amplify light from a low power seed source of a few milliwatts to final outputs of 100s of kilowatts of peak power. Each gain stage requires multiple fiber components. For example, illustrative fiber amplifier gain stage 200 can include a pump signal combiner 202, a gain stage 204 including Ytterbium-doped fiber, an optical isolator 206, a band pass filter 208, and forward and backward tap couplers 210.

The gain stage 204 may require a semiconductor pump diode 212 to create a population inversion in the doped fiber, which then provides the gain for signal light 214. Pump light 216 and signal light 214 can be merged together in pump signal combiner 202, at which point they propagate in the same gain stage 204 fiber. After gain stage 204 comes optical isolator 206, which prevents back propagating light from reaching the gain fiber. This is necessary to prevent damage to upstream optics and to preserve the gain. Bandpass filter 208 can be centered at the wavelength of signal light 214 to eliminate any amplified spontaneous emission from the gain medium at wavelengths outside the signal wavelength. Tap couplers 210 allow for monitoring both the forward and backward propagating light for diagnostic purposes.

With existing fiber laser systems, the various components illustrated in FIG. 2 may be individually packaged, such as shown in FIG. 2A. As shown, each component may have fiber on each end (e.g., fibers having lengths in the range of tens of centimeters) and the individually packaged components must be spliced into the system one at a time.

It is appreciated herein that one of the factors limiting the total output power from a fiber laser is nonlinearities generated by fiber length. Reducing the amount of optical fiber in each gain stage allows for improved laser performance and power scaling. It also allows for easier fiber routing and management during the initial build of the laser system.

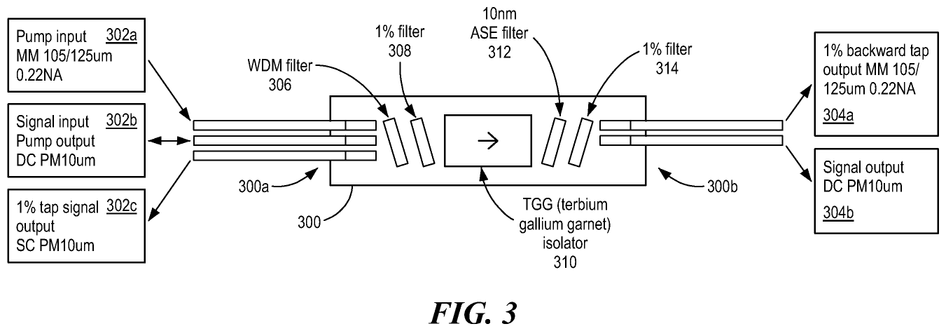

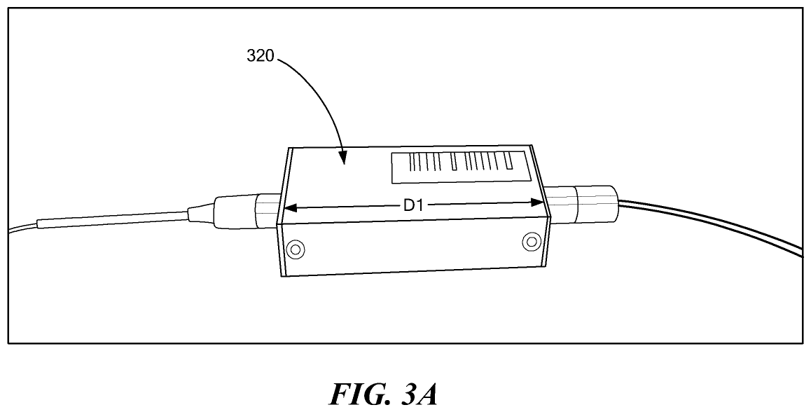

FIG. 3 shows an example of a hybrid device 300 that can include multiple gain stage components integrated within a single device or package, thereby reducing optical fiber and providing improved laser performance and power scaling.

Three fibers 302a-c can be connected to a first end 300a of device 300, sometimes referred to as the “input.” A pump input fiber 302a can carry pump light into device 300 and, for example, may be 105/120 um multimode fiber. A signal input fiber 302b can carry signal light into device 300 and also carry pump light out of the device 300. Signal input fiber 302b may be 10 um core polarization maintaining (PM) fiber, for example. A tap signal output fiber 302c can be used as a tap to monitor light going into device 300 by carrying a fraction of that light out of the device 300. Tap signal output fiber 302c may be 10 um PM fiber, for example.

Two fibers 304a,b can be connected at a second end 300b of device, sometimes referred to as the “output.” A backward tap output fiber 304a can be used as a backward tap output to measure any backward propagating light that is generated downstream of device 300 (i.e., light generated by devices connected directly or indirectly to the second end 300b of device 300). Backward tap output fiber 304a may be 105/125 um fiber, for example. Signal output fiber 304b can carry signal light out of device 300 and, for example, may be 10 um PM fiber.

Hybrid device 300 includes a wavelength division multiplexing (WDM) filter 306, a forward tap filter 308, an isolator 310, an amplified spontaneous emission (ASE) filter 312, and a backward tap filter 314, arranged as shown. In some embodiments, tap filter 308 and/or tap filter 314 may be so-called N % filters, meaning they are configured to filter out approximately N % of light (e.g., 1% of light) via splitting, reflection, or other means. In some embodiments, isolator 310 can include a terbium gallium garnet (TGG) isolator.

Hybrid device 300 is designed to be used in a counter pumping configuration, so pump light enters on pump input fiber 302a and then gets reflected back by WDM filter 306 into the signal input fiber 302b. Forward tap filter 308 can be configured to reflect a portion (e.g., 1%) of signal light into tap signal output fiber 302c for monitoring or other use. Isolator 310 is configured to prevent backward propagating light from entering input signal fiber 302b. ASE filter 312 can filter unwanted out-of-band light from the signal light. The signal light is then coupled into signal output fiber 304b. Backward tap filter 314 can filter/split out a portion (e.g., 1%) of backward propagating light onto backward tap output fiber 304a for monitoring or other use.

Hybrid device 300 combines the functionality of an optical isolator, band pass filter, forward and backwards tap coupler, and a pump signal combiner into one small, compact device. This reduces both fiber nonlinearities and build complexity. FIG. 3A illustrates how the hybrid device 300 of FIG. 3 can be packaged within a compact housing. In some examples, the housing may have a length D1 of two inches or less.

One or more instances of hybrid device 300 may be used within a fiber laser system. For example, one instance of hybrid device 300 may be used within each channel 114 of the coherently combined pulsed fiber laser system 100 of FIG. 1. More specifically, hybrid device 300 may be used within the second-stage fiber amplifier (FA2) 124b in each channel, helping to reduce nonlinearities at that stage of amplification.

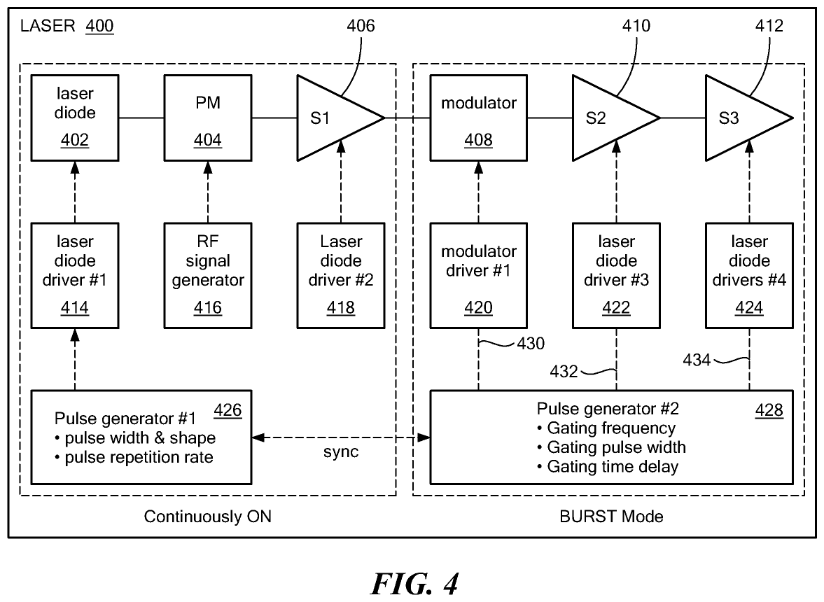

Turning to FIG. 4, high-extinction burst-mode operation of pulsed fiber lasers is important for sensing applications. In burst mode, the output signal emitted by a fiber laser system is turned on for relatively brief periods of times (“bursts”) and is turned off at other times. Each burst can include multiple output pulses. Burst mode can be contrasted with continuous mode whereby a steady stream of laser pulses is output (i.e., the fiber laser output is always on). By turning the emitted signal on and off with high extinction, sensing modalities with aggressive signal-to-noise-ratio (SNR) requirements are enabled.

A laser system 400 can use built-in gating to allow a laser system to operate in a burst mode using only electronics and fiber, e.g., without requiring a mechanical device such as a chopper wheel to turn the output beam on/off.

Illustrative system 400 includes a laser diode 402, a phase modulator (PM) 404, a first-stage fiber amplifier (S1) 406, a modulator 408, a second-stage fiber amplifier (S2) 410, and a third-stage fiber amplifier (S1) 412, which components may be connected by fiber in a cascade arrangement. System 400 further includes the following electronics: a first laser diode driver 414 coupled to drive laser diode 402, an RF signal generator 416 coupled to PM 404, a second laser diode driver 418 coupled to drive first-stage fiber amplifier 406, a modulator driver 420 coupled to drive modulator 408, a third laser diode driver 422 coupled to drive second-stage fiber amplifier 410, and a fourth laser diode driver 424 coupled to drive third-stage fiber amplifier 412. System 400 further includes a first pulse generator 426 coupled to first laser diode driver 414 and a second pulse generator 428 coupled to modulator driver 420, third laser diode driver 422, and fourth laser diode driver 424.

Modulator 408 is configured to act as a controllable optical switch to allow or block light traveling through fiber from first-stage fiber amplifier 406 to second-stage fiber amplifier 410. In some embodiments, modulator 408 may include a fiber optical acousto-optic modulator (AOM). AOMs and other types of optical switches have a maximum power at which they can operate, typically in the range of a few watts. Thus, modulator 408 may be placed before the second- and third-stage fiber amplifiers 410, 412 (before amplification of the signal higher power that exceeds to the switch's rating).

Laser system 400 of FIG. 4 may correspond to at least a portion of system 100 of FIG. 1. For example, amplifiers 406, 410, and 412 (S1, S2, and S3) in FIG. 4 may correspond to channel amplifiers 124a, 124b, and 124c (FA1, FA2, and FA3), respectively, of FIG. 1.

Operation of system 400 is now described. First pulse generator 426 provides the pulse width, shape, and repetition rate, which first laser diode driver 414 converts to an optical seed. First-stage fiber amplifier 406 may be continuously in an ON state. Modulator 408 chops the optical signal from first-stage fiber amplifier 406, governed by a gating signal 430 provided by second pulse generator 428. Gating signal 430 can take a first value—e.g., zero voltage—indicating an OFF state and a second value—e.g. a non-zero voltage—indicating an ON state. Second pulse generator 428 sets the frequency, pulse width, and time delay of gating signal 430.

In addition to generating gating signal 430 to control modulator 420, second pulse generator 428 can generate signals 432 and 434 to control second-stage fiber amplifier 410 and third-stage fiber amplifier 412, respectively. In more detail, control signal 432 can be used by third laser diode driver 422 to turn on/off a pump diode used to power second-stage fiber amplifier 410, and control signal 434 can be used by fourth laser diode driver 424 to turn on/off a pump diode used to power third-stage fiber amplifier 412.

For a fiber amplifier to perform without being damaged, it is generally necessary to ensure that signal light is entering the amplifier before it is turned on. That is, all upstream optical components should be in an ON state. Thus, before second-stage amplifier 410 is turned on, modulator 408 should be turned on, and before third-stage amplifier 412 is turned on, second-stage amplifier 410 should be turned on. To achieve these conditions, second pulse generator 428 can synchronously control (i.e., turn on/off) modulator 408, second-stage fiber amplifier 410, and a third-stage fiber amplifier 412 using signals 430, 432, and 434 according to one or more timing sequences.

In some embodiments, the first and second pulse generators 426 and 428 can be synchronized, such as shown in FIG. 4.

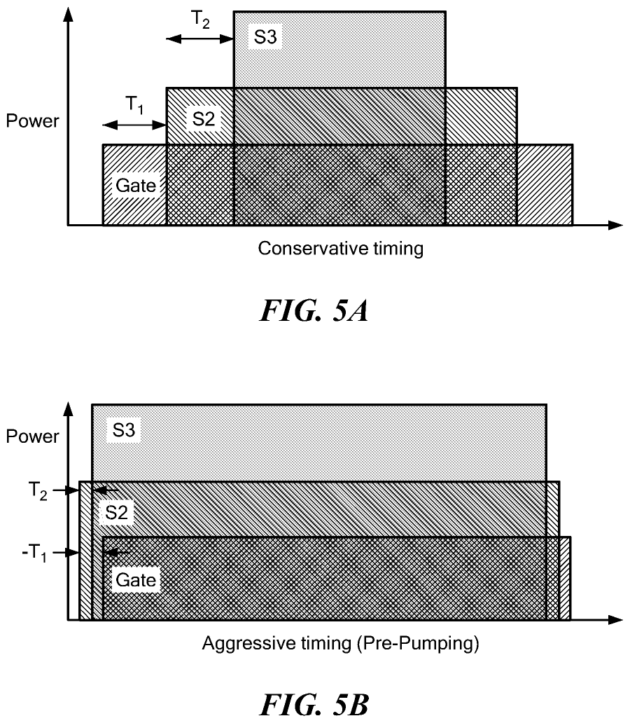

Referring to FIG. 5A, according to a “conventional” (or “conservative”) burst mode timing sequence, the timing between the gating signal 430 used to control modulator 408 and the control signals 432, 434 used to control the downstream second- and third-stage fiber amplifiers 410, 412 (S2 and S3) can be set conservatively to ensure safety of the laser system.

Using conservating timing, a pump laser diode is never on before light from a previous stage has seeded the relevant stage. That is, the amplification stage associated with that pump laser diode does not begin energizing until light from a previous stage has seeded the relevant stage. For example, as shown in FIG. 5A, at the beginning of a burst, S2 can be turned on T₁ time units after the modulator (“Gate”) and S3 can be turned on T₂ time units after S2. Likewise, at the end of the burst, S3 can be turned off some time before S2, and S2 can be turned off some time before the modulator (“Gate”).

In some embodiments, T₁ and T₂ can be selected based on the power-up time for second- and third-stage fiber amplifiers 410 and 412, respectively. For example, T₁ may be set equal to the amount of time it takes modulator 408 to reach X % (e.g., 90%) of its maximum power. Likewise, T₂ may be set equal to the amount of time it takes second-stage fiber amplifiers 410 to reach Y % (e.g., 90%) of its maximum power.

With this type of conventional approach, achieving full output power (depicted as S3 in FIG. 5A) takes T₁+T₂ time units. Faster burst mode turn on/off times (i.e., higher duty cycles) may be desirable in some applications.

Referring to FIG. 5B, to achieve faster burst mode turn on/off times, a technique referring to herein as pre-pumped built-in gating may be used. Here, more aggressive timing may be used, with certain stages being energized (or “pumped”) prior to seeding. As shown in FIG. 5B, the S2 laser diode can begin to be energized T₁ time units before the start of the gating signal, which allows the S3 laser diode to be turned on significantly earlier. Here, T₁ may be selected (e.g., using a calibration process) such that S2 can be at least partially energized prior to the gate being turned on, but while also minimizing/mitigating risk of damage to S2. A similar approach can be used to pre-pump S3.

TABLE 1

| Values are in μs and relative to | Stage 2 | | | Stage 3 |
|---|---|---|---|---|
| the gating signal ON/OFF state | 20 Hz | 200 Hz | 1 kHz | 200 Hz |
| Conventional | 70/70 | 70/70 | 70/70 | 280/280 |
| Pre-Pumped | −105/10 | −95/10 | −43/5 | 140/140 |

Table 1 summarizes the timing differences between the two modes of operation. In the table, the notation N1/N2 refers to N1 μs after the gating signal is in the ON state and N2 μs before the gating signal is in the OFF state. It will be appreciated that N1 and N2 relate to T₁ and T₂ in FIGS. 5A and 5B.

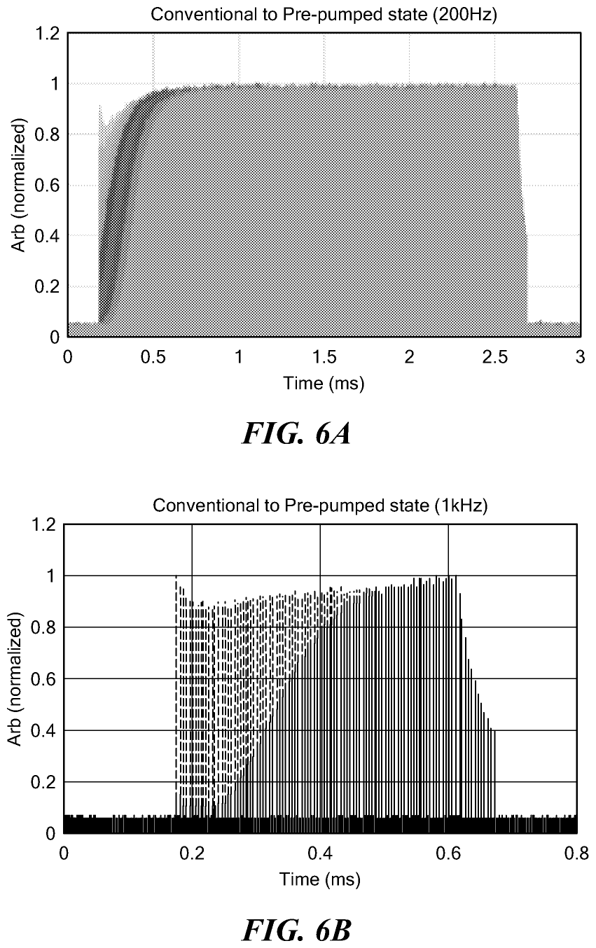

FIGS. 6A and 6B show average power output (y-axis) over time (x-axis) for a laser system with pre-pumped built-in gating (e.g., laser system 400 of FIG. 4). In FIG. 6A, corresponding to 200 Hz operation, the variable-colored bands on the left side of the graph illustrate burst mode turn-on using pre-pumping, whereas the solid grey on the right side corresponds to conventional burst mode turn-on. In FIG. 6B, corresponding to 1 kHz operation, the light region on the left side of the graph corresponds to pre-pumping, whereas the dark region on the right side corresponds to a conventional approach.

The technique described herein provides a significant improvement in performance over existing systems that use built-in gating. This improvement is evident in the shape of the burst pattern of the second-stage output as seen in FIGS. 6A and 6B. Through quantitative analysis, the inventors have demonstrated a nearly 55% improvement in average power output over conventional timing at 1 kHz burst rate. In addition, this mode of operation enables operation in burst repletion frequencies of 10+ kHz, previously not achievable. The inventors have further demonstrated a third-stage improvement in average power of at least 14% with a burst rate of 200 Hz.

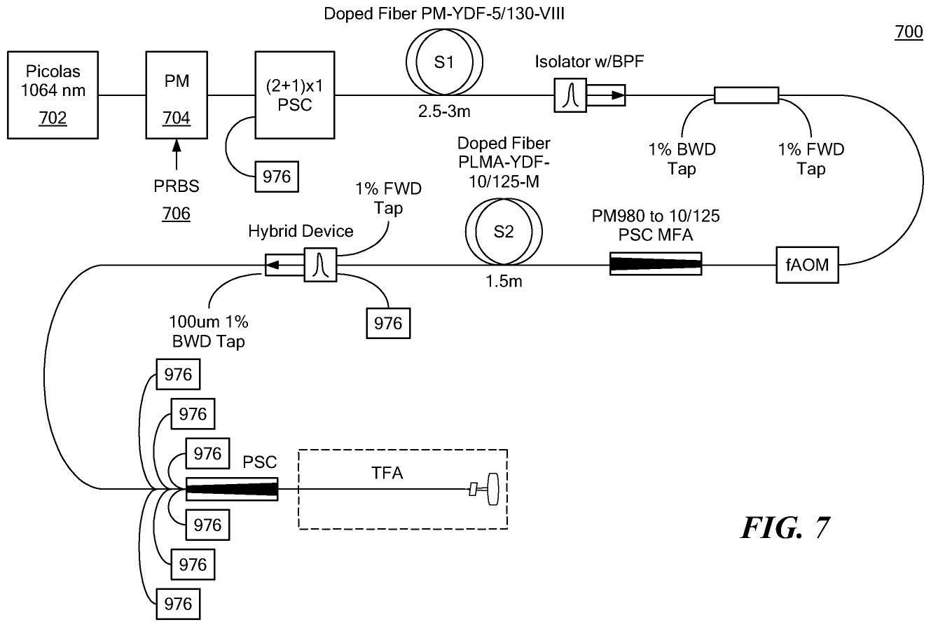

Turning to FIG. 7, high power fiber laser systems may be limited in power by stimulated Brillouin scattering (SBS). If left uncompensated, SBS will cause light to propagate backwards through a fiber laser system and damage the upstream optics, leading to a catastrophic laser failure. High-power fiber laser systems generally need to employ some sort of SBS mitigation technique. SBS can be compensated by applying a pseudorandom binary sequence (PRBS) pattern to an optical phase modulator. This pattern effectively broadens the optical spectrum and mitigates the effects of SBS.

FIG. 7 shows an example of a pulsed fiber laser system 700 with active PRBS linewidth broadening. System 700 includes a seed laser 702 coupled to a phase modulator (PM) 704, among various other components shown or not shown in the figure. PM 704 may perform linewidth broadening on the output of seed laser 702 using a PRBS signal 706.

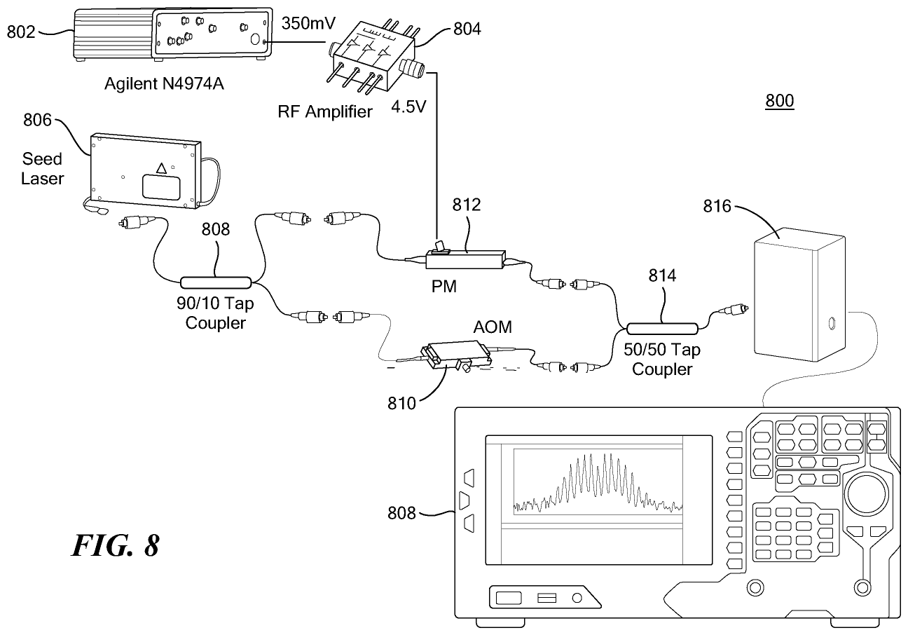

FIG. 8 shows a conventional carrier suppression monitoring setup 800. As shown, a PRBS signal may be generated by signal generator 802, which can include high-speed electronics. In some embodiments, signal generator 802 may be an AGILENT N4974A. However, the peak-to-peak voltage, Vpp, of the PRBS signal coming out of signal generator 802 is too low to be used with a phase modulator. Each phase modulator has a characteristic voltage Vpi. It is important to match the PRBS Vpp to the phase modulator's Vpi. In order to do this a high-speed RF amplifier 804 can be used. High-speed RF amplifier 804 may include multiple gain stages that need to be tuned by adjusting the applied voltage to match the phase modulator's Vpi.

In order to ensure that the optical spectrum is sufficiently broadened to suppress the SBS, a heterodyne carrier suppression technique can used. Light from a seed laser 806 can be split by a tap coupler 808, with a portion of the light directed into an AOM 810 to shift its frequency, and the remainder of the light directed into a phase modulator (PM) 812. In some cases, tap coupler 808 may be a 90/10 tap coupler, with 10% of the light going to AOM 810 and 90% going to PM 812. In some embodiments, AOM 810 may shift light frequency by about 200 MHz.

Signal generator 802 generates a PRBS signal that is amplified (amplifier 804) before going into PM 812. The PM 812 imprints this electrical signal onto the phase of the light passing through it. The light can then recombine at a tap coupler 814 (e.g., a 50/50 tap coupler) before being picked up by a high-speed photodetector 816. The RF output from photodetector 816 can be observed using an RF spectrum analyzer 818.

In some embodiments, photodetector 816 may be an EOT 3500, however in general any photodetector with a high enough bandwidth may be sufficient for the carrier suppression monitoring. In some embodiments, photodetector 816 may be selected to have a bandwidth high enough to see the AOM carrier frequency and any neighboring tones.

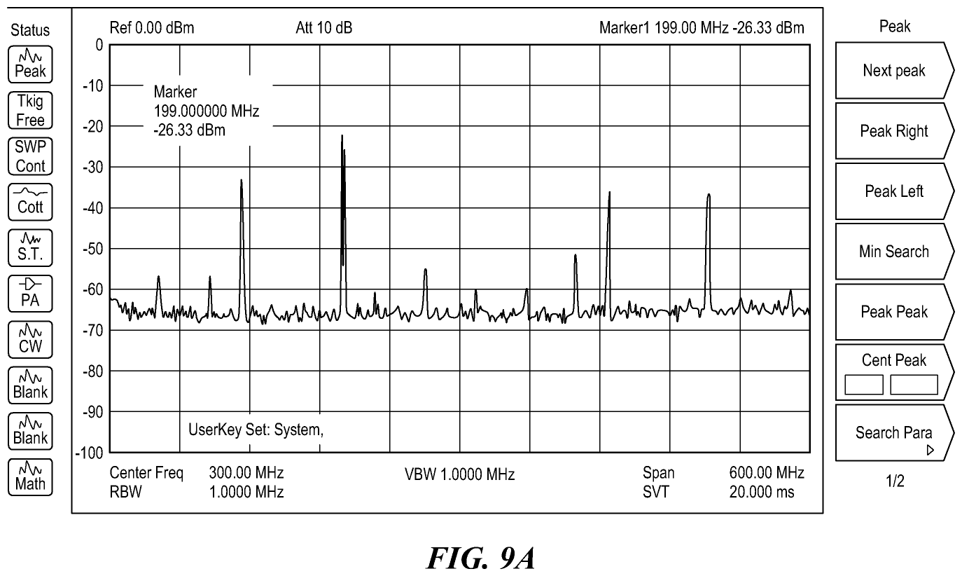

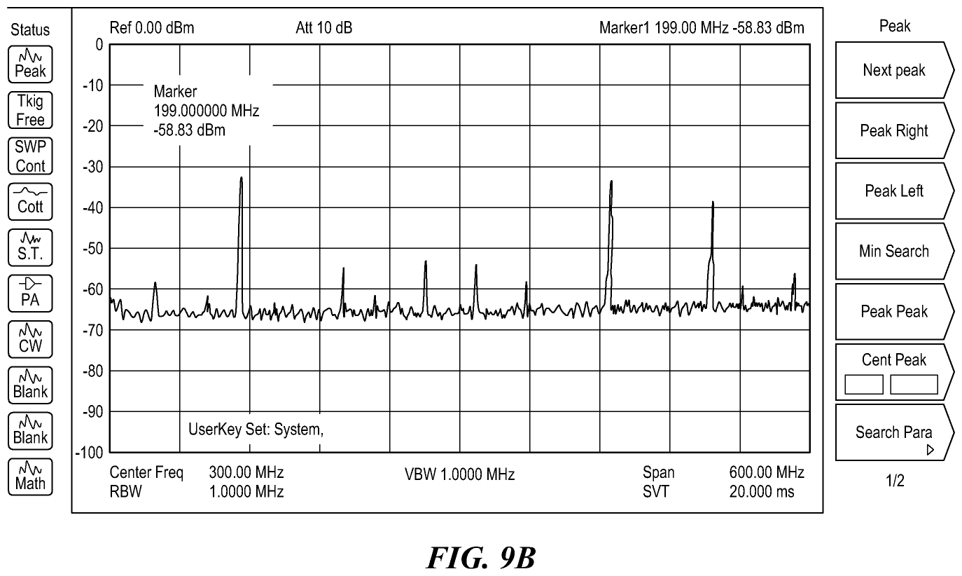

With no PRBS pattern applied to PM 812, the RF spectrum will have a single peak at the AOM frequency, such as 200 MHz. FIG. 9A shows an example of a spectrum that can result when a PRBS pattern is applied to PM 812. There are multiple tones present in the spectrum, with the 200 MHz carrier tone the largest. To ensure sufficient SBS mitigation, the carrier tone needs to be below the highest neighboring tones. This can be accomplished by tuning the RF amplifier 804. Once the RF amplifier 804 is tuned, the spectrum may resemble that in FIG. 9B. Here, the carrier is suppressed about 20 dB below the nearest tone. For many systems, it may be necessary to tune the RF amplifier on a regular basis (e.g., daily), which requires hooking up the photodetector to the RF spectrum analyzer.

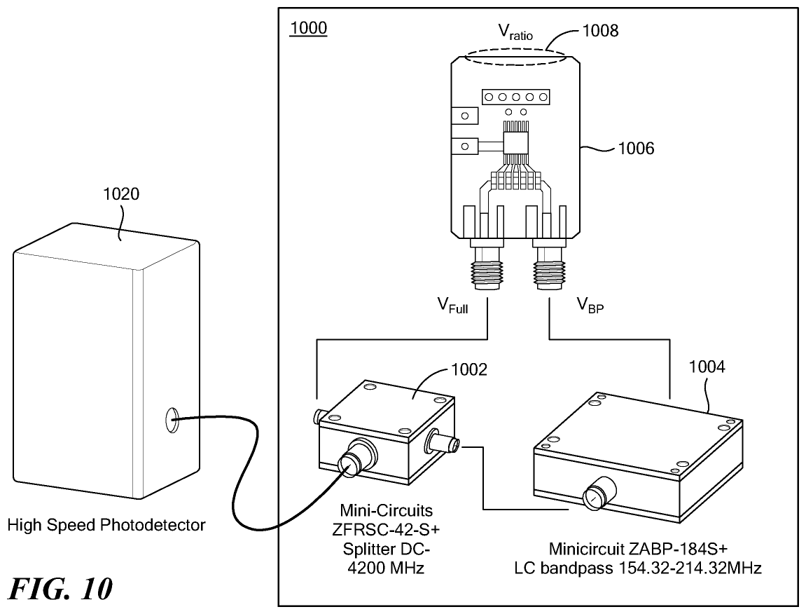

FIG. 10 shows an example of a carrier suppression monitoring circuit 1000 that improves on the conventional approach described above. Circuit 1000 is shown in FIG. 10 as a collection of RF components. These components can be packaged into a housing, providing a device (or “box”) suitable for a given application. Carrier suppression monitoring circuit 1000 eliminates the need for the RF spectrum analyzer and replacing it with a small circuit and readout display.

Illustrative monitoring circuit 1000 includes a 2-way power splitter 1002, a bandpass filter 1004, and a measurement board 1006. In some embodiments, power splitter 1002 may be a ZFRSC-42-S+ splitter from MINI-CIRCUITS. In some embodiments, bandpass filter 1004 may be a ZABP-184S+ LC bandpass filter from MINI-CIRCUITS. In some embodiments, measurement board 1006 may be an AD8302 board from ANALOG DEVICES. More generally, measurement board 1006 can be provided as any electronics capable of measuring gain/loss and phase of an RF signal.

Power splitter 1002 can take the output signal from a photodetector 1020 (which may correspond to photodetector 816 of FIG. 8, for example) and split this signal into two outputs, Vfull and Vbp. Bandpass filter 1004 is connected to the Vbp output of power splitter 1002. Bandpass filter 1004 can be centered around the carrier frequency of an AOM (e.g., AOM 810 of FIG. 8), which may be about 200 MHz in some examples. This isolates the output of the bandpass filter to be just the carrier tone to be minimized. Measurement board 1006 has a first input connected to the Vfull output of power splitter 1002, and a second input connected to receive the output of bandpass filter 1004 (i.e., a filtered version of Vbp). Measurement board 1006 can be programmed or otherwise configured to calculate an amplitude ratio Vratio by comparing Vfull and Vbp, and to provide Vratio at an output 1008. A digital readout (not shown) may be coupled to output 1008 of measurement board 1006 for displaying Vratio to a user.

Measurement board 1006 compares the power in the carrier frequency to the total power in the RF spectrum. Therefore, this ratio can be used as a measure of the carrier (e.g., 200 MHz carrier). By minimizing this number, the user can be assured that the optical spectrum is sufficiently broadened to mitigate the effects of SBS. As an example, the digital readout may indicate Vratio is 0.775V when the carrier is maximized and 0.120V when the carrier is minimized. This gives a very easy to read indicator to the user when trying to tune the RF amplifier.

In some embodiments, when building a laser system, the values of Vratio can be calibrated while using an RF spectrum analyzer. Once this is done, a Vratio threshold can be set to let the user know when the carrier is sufficiently suppressed to enable safe operation of the laser.

In some embodiments, instead of using a digital readout, the value of Vratio can also be displayed in a graphical user interface (GUI) of a computer system used to operate the laser. This can simplify the laser turn on process and eliminate the need for a bulk, expensive RF spectrum analyzer to follow around any laser PRBS system. The user can observe the number displayed in the GUI and adjust the values accordingly also using the GUI. In some embodiments, this process can be automated where a software control loop can scan different RF amplifier voltages until the Vratio input is sufficiently minimized.

Carrier suppression monitoring circuit 1000 can simplify the monitoring of the carrier suppression signal used in PRBS broadening systems for high power fiber laser systems. SWaP can be greatly reduced by eliminating the need for an RF spectrum analyzer. The single input Vratio makes the system more user friendly and allows for the incorporation into a “turn-key” system where the carrier suppression tuning is included in the laser startup routine.

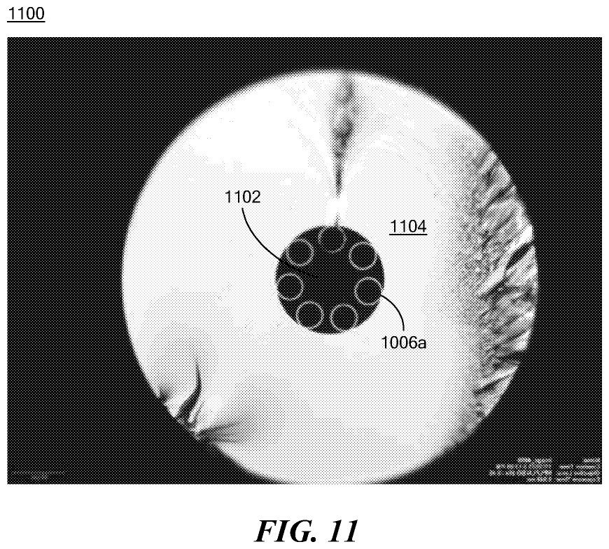

Turning to FIG. 11, coherent beam combining (CBC) allows fiber lasers to scale past the inherent power limitations of a single fiber laser. Nonlinearities limit the amount of power optical fibers with a glass core can carry. Coherent beam combining provides a means to take the outputs of multiple optical fiber amplifiers and combine them in a coherent manner. This involves a phase control feedback loop where the phase of each optical fiber is continuously adjusted to align with the other channels. Because of these fiber limitations, high peak power pulsed laser system beam delivery and combing optics are limited to what can be done with free space optics. The outputs from the final high power amplification stages must be aligned in the free space. All beam delivery must also be done in the free space. This adds limitations to the architecture of any potential applications.

Hollow core fibers provide a means to enable flexible beam delivery. As illustrated in FIG. 11, instead of a glass core, a hollow core fiber 1100 utilizes an air core 1102 surrounded by glass 1104. This allows them to handle optical powers several orders magnitude higher than any fiber with a glass core due to physical limits of the later. Light can be coupled directly from the output of a fiber amplifier directly into the hollow core fiber and then routed to the beam combiner or beam delivery system before being coherently combined.

As shown in FIG. 11, a plurality of glass fibers (e.g., glass fiber 1006a) can be formed around a circumference of air core 1102 to assist with guiding of light through the fiber. While seven such glass fibers are shown in the example of FIG. 11, other numbers may be provided. In some embodiments, the glass fibers may be omitted.

According to some embodiments, hollow core fibers similar to hollow core fiber 1100 may be used within pulsed fiber laser system, such as within coherently combined pulsed fiber laser system 100 of FIG. 1. For example, a hollow core fiber may be coupled to an output of the final-stage fiber amplifier (FA3) 124c in each channel 114 of FIG. 1. This can allow for more efficient beam combining, e.g., using a phased array-type or parallel plate-type beam combiner.

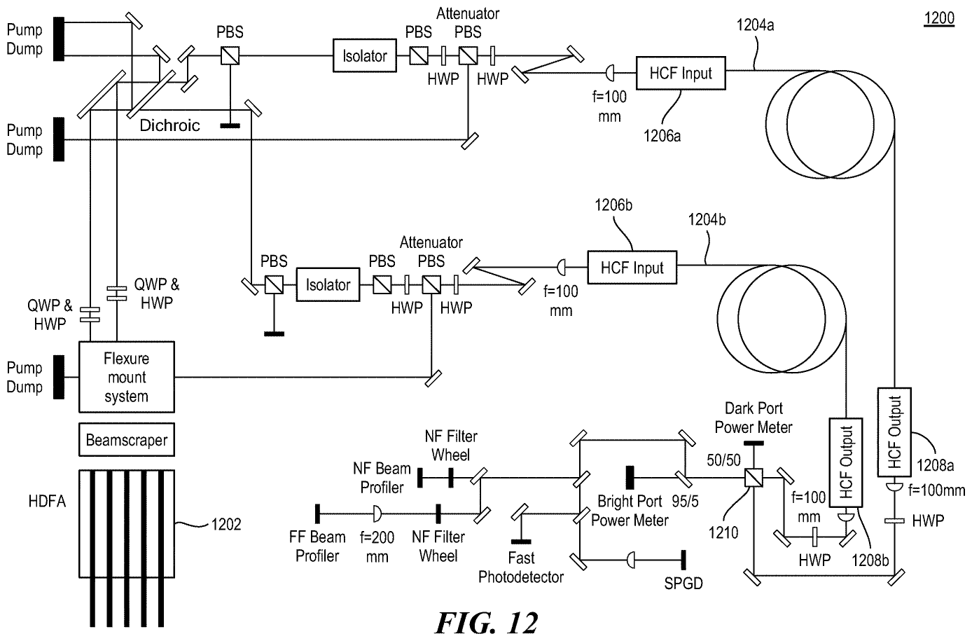

A means to couple light from the output of a high peak power fiber amplifier can be provided, and it can be demonstrated that the output of a hollow core fiber is combinable. Light from two highly doped fiber amplifiers (HDFAs) can be coupled into two hollow core fibers. The outputs of these hollow core fibers can then be coherently combined in both continuous wave (CW) and pulsed (e.g., 5 ns pulse width, 200 kHz rep rate, 100 kW peak power) operational modes. FIG. 12 shows an example of such an optical setup.

With illustrative system 1200, light (e.g., 1064 nm light) from HDFAs can be first filtered through a beam scraper and then collimated using lenses contained in the flexure mount system. A quarter wave plate (QWP) and half wave plate (HWP) can be used to set the polarization. The light can then pass through a dichroic filter to eliminate pump light (e.g., 976 nm pump light). The light is next passed through a polarizing beam splitter (PBS) to clean up the polarization before passing through an optical isolator which prevents back reflections. Afterwards another PBS can be provided to attenuate the laser beam to limit the amount of power going into the hollow core fiber (HCF) during alignment. Two mirrors can be used for alignment of the beam into the HCF and the light is focused into the HCF using a lens (e.g., a f=100 mm lens).

The outputs from the HCF can then be passed through another HWP to set the polarization before being overlapped on a beam splitter (e.g., a 50:50 beam splitter). Two power meters can be used to monitor the output of each arm of the beam splitter. In some cases, a small amount of light can be picked off and used for diagnostics. This includes alignment using a near field and far field beam profile camera.

System 1200 can further include a photodetector for a phase control feedback loop in the diagnostic arm, along with a fast photodetector to monitor the output pulses from the hollow core fibers. The pulses can be aligned temporally to arrive at the beam splitter at the same time.

System 1200 includes an HDFA 1202 and one or more hollow core fibers (HCF) 1204a, 1204b, etc. (1204 generally) each having a respective input 1206a, 1206b, etc. (1206 generally) and a respective output 1208a, 1208b, etc. (1208 generally). The hollow core fiber inputs 1206 can be coupled to one or more outputs of the HDFA 1202 via free space optical components (e.g., mirrors, splitters, isolators, etc.), such as shown. HDFA 1202 in FIG. 12 may correspond to collection of channel final-stage fiber amplifiers (FA3) in FIG. 1. The hollow core fiber outputs 1208 can be combined, for example using a 50/50 splitter 1210. Additional free space optics can be provided after the 50 splitter 1210 for measuring, filtering, and outputting the coherently combined beam, such as shown. In the example shown, two channels of coherent beam combining are shown (i.e., two hollow core fibers 1204a and 1204b), however in general any number of channels and hollow core fibers may be used.

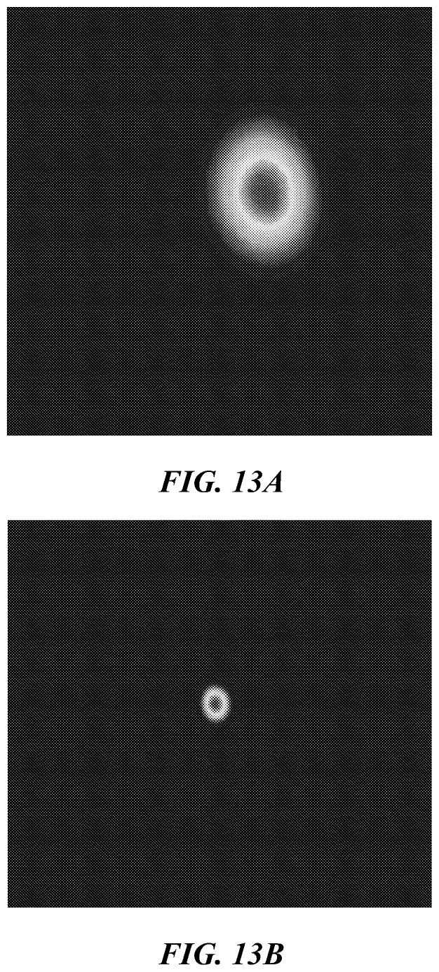

A coupling efficiency of about 85% of the light from the HDFA into the HCF in both CW and pulsed modes can be achieved. The output beam from the HCF is Gaussian in both the near field (FIG. 13A) and far field (FIG. 13B).

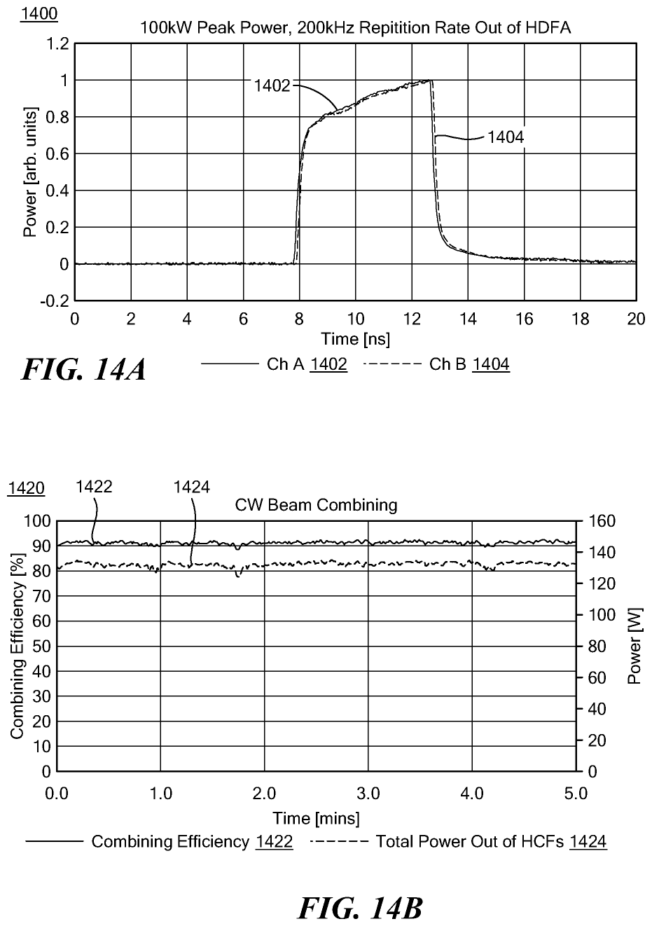

Graph 1400 of FIG. 14A illustrates output pulses from the HCF of FIG. 12, with plot 1402 corresponding to one channel (“Ch A”) and plot 1404 corresponding to the other channel (“Ch B”).

As illustrated by graph 1420, coherent beam combining in the CW mode achieved over 90% beam combining efficiency with an output power over 130 W average power. Plot 1422 shows combining efficiency and plot 1424 shows total power out of the HCFs.

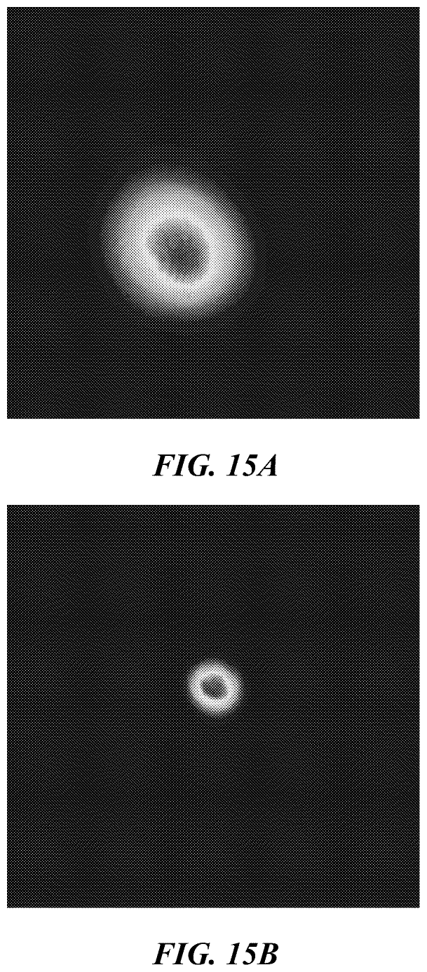

FIGS. 15A and 15B show the CW combined beam. As with the individual channels, the combined beam is Gaussian in both the near (FIG. 15A) and far field (FIG. 15B).

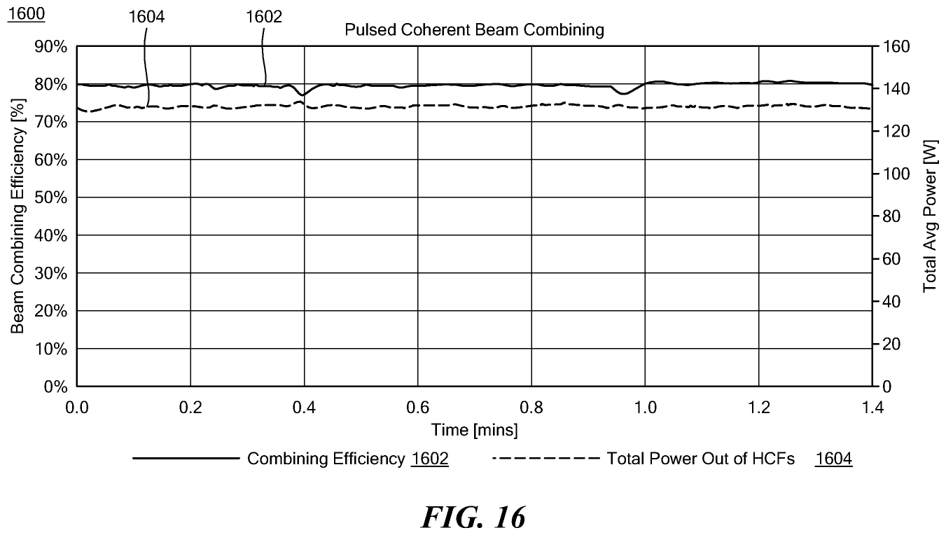

Pulsed beam combining can also be done using hollow core fibers. Each HDFA can produce, for example, 5 ns pulses at a repetition rate of 200 kHz, with an average power of 100 W and a peak power of 100 kW. The same setup can be used as in CW beam combing. As demonstrated by graph 1600 of FIG. 16, 80% beam combining efficiency (plot 1602) with an average power of 130 W (plot 1604) can be achieved.

Thus, disclosed herein is the use of high-power coherent beam combining using a hollow core fiber. Utilizing the hollow core fiber allows for novel beam delivery system designs. The output from an HDFA can be coupled into a hollow core fiber and then routed according to the needs of a particular application, decoupling the need for the HDFA output to be directed by free space optics.

The general concepts described herein can enable the development of a phased array beam combiner in place of a 50:50 beam combiner, for example.

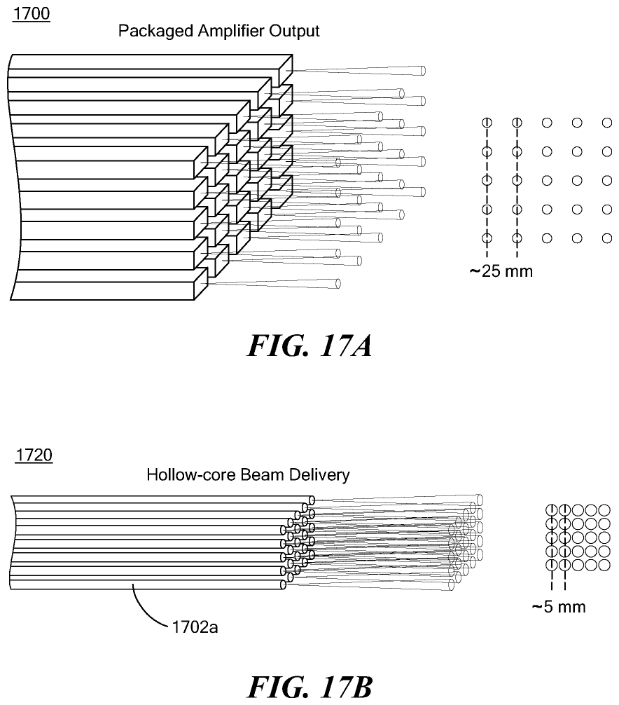

Turning to FIGS. 17A and 17B, one potential application of this type of architecture is scaling to a system of twenty-five (25) channels to be coherently combined. FIG. 17A illustrates use of packaged amplifiers to form a grid structure 1700 for launching the beams into free space. FIG. 17B illustrates use of hollow-core fibers to form a grid structure 1720 for launching the beams into free space. As shown, instead of having a long line of twenty-five (25) HDFAs or arranging the HDFAs on top of each other in a grid, the outputs of each of the HDFAs can be directly coupled into a hollow core fiber (FIG. 17B). The outputs of these hollow core fibers can then be placed in a 5×5 grid with millimeter spacing, for example. This allows for beam combining in a phased array configuration and, notably, would greatly reduce the need for complex optical assemblies to increase the array fill factor. The number of channels and grid dimensions can be varied according to the needs of particular application.

Relating FIG. 17B to FIG. 1, each of the hollow core fibers (e.g., fiber 1702a) may be coupled to an output of a final-stage fiber amplifier (FA3) 124c in a respective one of the channels.

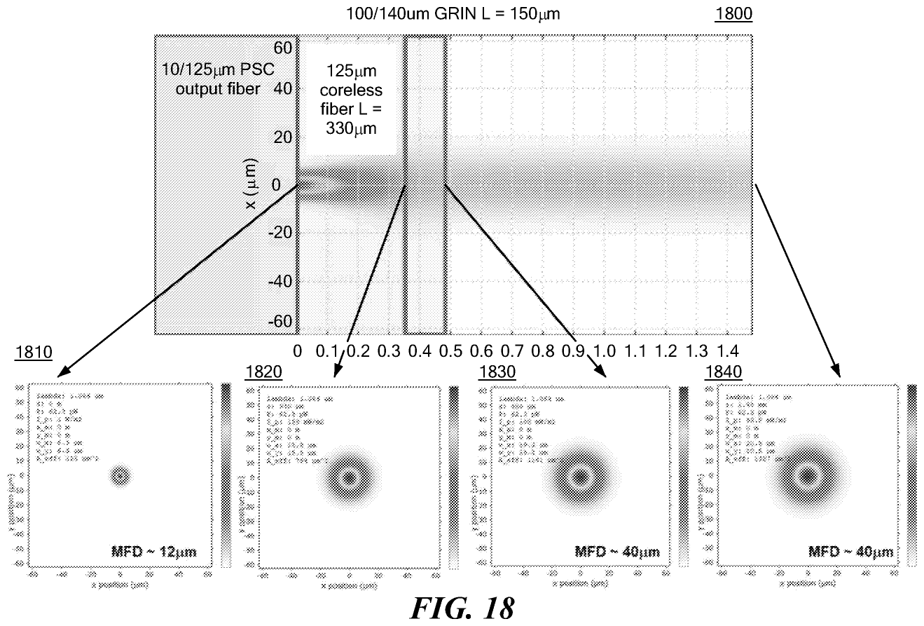

Turning to FIG. 18, according to another aspect of the present disclosure, a technique is described for low-loss coupling of a laser beam from a pump signal combiner to the highly-doped rare-earth fiber within a fiber amplifier, e.g., within a final-stage fiber amplifier (FA3) 124c such as shown with the system of FIG. 1. It is appreciated herein that existing FA3 amplifiers may be limited to about 100 W of output power. The approach described herein can allow for significantly higher output powers, particularly with pulsed mode operation.

FIG. 18 illustrates simulation results depicting transition of a signal beam from a pump signal combiner into a highly rare earth doped fiber within a fiber amplifier, according to some embodiments. A graph 1800 illustrates beam propagation simulation showing spatial beam mode field expansion from 10/125 um pump signal combiner output fiber through a high doped Yb fiber. The pump signal combiner output fiber and a high doped Yb fiber can be connected via a section of coreless fiber and a section of graded index fiber. The four sections of fiber may be spliced together. The horizontal axis of graph 1800 corresponds to distance (z-axis position) along the length of the combined fiber in mm and the vertical axis corresponds to 1-dimensional (x-axis position) beam cross section in micron.

Graphs 1810, 1820, 1830, and 1840 show cross-sections of the beam taken at the outputs of the four fiber sections, with the horizontal axes corresponding to x-axis position and the vertical axes corresponding to y-axis position. From left to right in the figure, graph 1810 corresponds to an output of a 10/125 um pump signal combiner output fiber section, graph 1820 corresponds to an output of a 125 um coreless fiber section, graph 1830 corresponds to a 100/140 um graded index fiber section, and graph 1804 corresponds to an output of the high doped Yb fiber. In some embodiments, the coreless fiber section may be approximately 330 um long. In some embodiments, the graded index fiber section may be approximately 150 um long.

As shown, the output fiber of the pump signal combiner can have a core diameter of about 10 um with a numerical aperture of about 0.07. The mode field diameter of the fiber core can be simulated to measure 12 um at a wavelength of 1064 nm. As the 12 um signal beam propagates through a 330 um long coreless fiber, it diverges, resulting in a 40 um beam diameter at the coreless fiber's terminus. Subsequently, the diverged signal beam can undergo collimation through a 150 um long 100 um graded index fiber. The collimated beam, featuring a 40 um beam diameter, can then introduced into the highly rare-earth doped fiber for amplification.

Using the disclosed transition technique, notable enhancements can be achieved, including augmentation of laser signal output beam quality generated from the fiber amplifier. Furthermore, the method ensures consistency and repeatability in the quality of the laser signal beam, which contributes to the overall effectiveness of the system.

As used in the claims or elsewhere herein, the term “comprising” does not exclude other elements or steps, and the indefinite article “a” or “an” does not exclude a plurality.

As used herein, the term “predetermined,” when referring to a value or signal, is used to refer to a value or signal that is set, or fixed, in the factory at the time of manufacture, or by external means, e.g., programming, thereafter. As used herein, the term “determined,” when referring to a value or signal, is used to refer to a value or signal that is identified by a circuit during operation, after manufacture.

Various embodiments of the concepts systems and techniques are described herein with reference to the related drawings. Alternative embodiments can be devised without departing from the scope of the described concepts. It is noted that various connections and positional relationships (e.g., over, below, adjacent, etc.) are set forth between elements in the claims, detailed description, and drawings. These connections and/or positional relationships, unless specified otherwise, can be direct or indirect, and the claimed inventions are not intended to be limiting in this respect. Accordingly, a coupling/connection of entities can refer to either a direct or an indirect coupling/connection, and a positional relationship between entities can be a direct or indirect positional relationship. As an example of an indirect positional relationship, references in the present description to element or structure A coupled/connected to element or structure B include situations in which one or more intermediate elements or structures (e.g., element C) is provided between elements A and B regardless of whether the characteristics and functionalities of elements A and/or B are substantially changed by the intermediate element(s).

Furthermore, it should be appreciated that relative, directional or reference terms (e.g. such as “above,” “below,” “left,” “right,” “top,” “bottom,” “vertical,” “horizontal,” “front,” “back,” “rearward,” “forward,” etc.) and derivatives thereof are used only to promote clarity in the description of the figures. Such terms are not intended as, and should not be construed as, limiting. Such terms may simply be used to facilitate discussion of the drawings and may be used, where applicable, to promote clarity of description when dealing with relative relationships, particularly with respect to the illustrated embodiments. Such terms are not, however, intended to imply absolute relationships, positions, and/or orientations. For example, with respect to an object or structure, an “upper” or “top” surface can become a “lower” or “bottom” surface simply by turning the object over. Nevertheless, it is still the same surface and the object remains the same.

The terms “disposed over,” “overlying,” “atop,” “on top,” “positioned on” or “positioned atop” mean that a first element, such as a first structure, is present on a second element, such as a second structure, where intervening elements or structures (such as an interface structure) may or may not be present between the first element and the second element. The term “direct contact” means that a first element, such as a first structure, and a second element, such as a second structure, are connected without any intermediary elements or structures between the interface of the two elements. The term “connection” can include an indirect connection and a direct connection.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

The terms “approximately” and “about” may be used to mean within ±20% of a target value in some embodiments, within ±10% of a target value in some embodiments, within ±5% of a target value in some embodiments, and yet within ±2% of a target value in some embodiments. The terms “approximately” and “about” may include the target value. The term “substantially equal” may be used to refer to values that are within ±20% of one another in some embodiments, within ±10% of one another in some embodiments, within ±5% of one another in some embodiments, and yet within ±2% of one another in some embodiments.

The term “substantially” may be used to refer to values that are within ±20% of a comparative measure in some embodiments, within ±10% in some embodiments, within ±5% in some embodiments, and yet within ±2% in some embodiments. For example, a first direction that is “substantially” perpendicular to a second direction may refer to a first direction that is within ±20% of making a 90° angle with the second direction in some embodiments, within ±10% of making a 90° angle with the second direction in some embodiments, within ±5% of making a 90° angle with the second direction in some embodiments, and yet within ±2% of making a 90° angle with the second direction in some embodiments.

In the foregoing detailed description, various features are grouped together in one or more individual embodiments for the purpose of streamlining the disclosure. This method of disclosure is not to be interpreted as reflecting an intention that each claim requires more features than are expressly recited therein. Rather, inventive aspects may lie in less than all features of each disclosed embodiment.

References in the disclosure to “one embodiment,” “an embodiment,” “some embodiments,” or variants of such phrases indicate that the embodiment(s) described can include a particular feature, structure, or characteristic, but every embodiment can include the particular feature, structure, or characteristic. Moreover, such phrases are not necessarily referring to the same embodiment(s). Further, when a particular feature, structure, or characteristic is described in connection knowledge of one skilled in the art to affect such feature, structure, or characteristic in connection with other embodiments whether or not explicitly described.

The disclosed subject matter is not limited in its application to the details of construction and to the arrangements of the components set forth in the detailed description or illustrated in the drawings. The disclosed subject matter is capable of other embodiments and of being practiced and carried out in various ways. As such, those skilled in the art will appreciate that the conception, upon which this disclosure is based, may readily be utilized as a basis for the designing of other structures, methods, and systems for carrying out the several purposes of the disclosed subject matter. Therefore, the claims should be regarded as including such equivalent constructions insofar as they do not depart from the spirit and scope of the disclosed subject matter.

Although the disclosed subject matter has been described and illustrated in the foregoing exemplary embodiments, it is understood that the present disclosure has been made only by way of example, and that numerous changes in the details of implementation of the disclosed subject matter may be made without departing from the spirit and scope of the disclosed subject matter.

Other variations to the disclosed embodiments can be understood and effected by those skilled in the art in practicing the claimed invention, from a study of the drawings, the disclosure, and the appended claims.

The mere fact that certain measures are recited in mutually different dependent claims does not indicate that a combination of these measures cannot be used to obtain an advantage.

Any reference signs in the claims should not be construed as limiting the scope.

All publications and references cited herein are expressly incorporated herein by reference in their entirety.

1. A pulsed fiber laser system comprising:
a seed laser configured to generate signal light; and
a phase modulator coupled to the seed laser to phase modulate the signal light;
a first gain stage coupled to the phase modulator to amplify the phase-modulated signal light;
a fiber optical acousto-optic modulator (AOM) coupled to pulse the amplified phase-modulated signal light;
a second gain stage coupled to the fiber AOM to amplify the pulsed signal light;
a splitter coupled to the second gain stage to split the pulsed signal light into a plurality of pulsed signals;
a plurality of channels each coupled to the splitter to receive a corresponding one of the plurality of pulsed signals, each of the plurality of channels comprising one or more gain stages to amplify the corresponding one of the plurality of pulsed signals and a transition of the amplified signal to free space; and
a beam combiner coupled to combine, in free space, the amplified signals of the plurality of channels.

2. The system of claim 1 wherein the signal light generated by the seed laser is continuous-wave (CW) light.

3. The system of claim 1 wherein the one or more gain stages of at least one of the plurality of channels includes a plurality of gain stages arranged in cascade.

4. The system of claim 1 wherein the beam combiner includes a parallel plate combiner.

5. The system of claim 1 comprising one or more hollow core fibers.

6. The system of claim 1 further comprising a high-doped fiber amplifier (HDFA) array corresponding to at least a portion of the one or more gain stages of the plurality of channels.

7. The system of claim 1 wherein, for at least one of the plurality of channels, the one or more gain stages includes a gain stage having multiple gain stage components integrated within a single hybrid device.

8. The system of claim 7 wherein the hybrid device comprises:
an input;
a wavelength division multiplexing (WDM) filter coupled to the input;
a forward tap filter coupled to the WDM filter;
an isolator coupled to the forward tap filter;
an amplified spontaneous emission (ASE) filter coupled to the isolator;
and a backward tap filter coupled to the ASE filter; and
an output coupled to the backward tap filter.

9. The hybrid device of claim 8 wherein the input comprises:
a pump input fiber to carry pump light into the device;
a signal input fiber to carry signal light into device and also carry pump light out of the device; and
a tap signal output fiber to carry a portion of the pump light and/or signal light out of the device.

10. The hybrid device of claim 8 wherein the output comprises:
a signal output fiber to carry signal light out of device; and
a backward tap output fiber to carry, out of the device, a portion of backward propagating light generated downstream of device.

11. The pulsed fiber laser system of claim 1 comprising a fiber arrangement, the fiber arrangement comprising:
a first section of 10/125 um pump signal combiner output fiber;
a second section of 125 um coreless fiber;
a third section of 100/140 um graded index fiber; and
a fourth section of high doped Yb fiber.

12. The pulsed fiber laser system of claim 11 wherein the four sections are spliced together.

13. The pulsed fiber laser system of claim 11 wherein a length of the second section is about 330 um.

14. The pulsed fiber laser system of claim 11 wherein a length of the third section is about 150 um.

15. The pulsed fiber laser system of claim 1 wherein the phase modulator is configured to suppress stimulated Brillouin scattering (SBS) within the system.

16. The pulsed fiber laser system of claim 15 comprising a suppression monitoring device to monitor the SBS suppression.

17. The pulsed fiber laser system of claim 16 wherein the suppression monitoring device includes:
an input configured to receive a signal from a photodetector;
a power splitter coupled to the input and configured to split the signal into a first signal (Vfull) and a second signal (Vbp);
a bandpass filter coupled to the power splitter to receive and filter the second signal;
a measurement board coupled to receive the first signal and the filtered second signal and configured to calculate an amplitude ratio (Vratio) based on the first signal and the filtered second signal; and
an output to provide the amplitude ratio.

18. A method for controlling a burst mode of a fiber laser system, the method comprising:
at a first time, commencing energization of a first fiber amplifier;
at a second time after the first time, changing a modulator to an ON state to allow signal light to pass to an input of the first fiber amplifier; and
at a third time after the first time, commencing energization of a second fiber amplifier coupled to an output of the first fiber amplifier.

19. The method of claim 18 wherein the third time is before the second time.
